(19) United States
(12) Patent Application Publication
(10) Pub. No.: US 2016/0287366 A1
(43) Pub. Date: Oct. 6, 2016

(54) VAPOR DELIVERY SYSTEM AND RELATED METHODS THEREOF

(71) Applicant: University of Virginia Patent Foundation, Charlottesville, VA (US)

(72) Inventor: Michael M. Scott, Charlottesville, VA (US)

(21) Appl. No.: 15/091,531

(22) Filed: Apr. 5, 2016

Related U.S. Application Data
(60) Provisional application No. 62/143,323, filed on Apr. 6, 2015.

(51) Int. Cl. A61D 7/04; A01K 29/00; A01K 1/03

(52) U.S. Cl. CPC A61D 7/04; A01K 1/031; A01K 29/005

(57) ABSTRACT

A system and related methods thereof involving self-administration of an agent to an animal. In certain embodiments, the system comprises an enclosure for the confinement of an animal; a sensor that produces a signal when purposefully activated by the animal in said enclosure, wherein the purposefully activation defines a first behavior of the animal that is located at a first behavior location; and an agent dispenser that is configured to provide the agent in the enclosure in response to the sensor being purposefully activated, wherein the agent is provided remotely from the first behavior location so as to require the animal to travel to the remotely provided agent at a remote provision location, wherein the traveling defines a second behavior of the animal. The system and related methods thereof can be used to provide a model system to evaluate the behavioral and/or physiological response(s) to a self-administered agent.

### RELATED APPLICATIONS

The present application claims priority from U.S. Provisional Application Ser. No. 62/143,323 filed Apr. 6, 2015, entitled “Vapor Delivery System and Method for Use in the Study of Drug Addiction in Model Organisms,” the disclosure of which is hereby incorporated by reference herein in its entirety.

### FIELD OF THE INVENTION

The present invention relates generally to the field of testing devices to be used for animal self-administration of an agent as well as method(s) for establishing such self-administration and method(s) of evaluating agents through animal self-administration.

### BACKGROUND

Addiction to drug is a serious affliction of the human population, leading to enormous governmental expenditures and having negative impacts on the lives of many people. The effects of a drug on and how the drug works in humans need to be known for many reasons including how the drug interacts with other drugs, the safety of a drug, and how to treat a person for drug addiction. Specific examples are how drug exposure affects the brains of adolescents and the behavior of adolescents, what drives consumption of the drug, and how to reduce interest in drug consumption. There is a need to create a model or paradigm that can effectively evaluate such drugs in humans.

An example of the need to evaluate drugs is in the e-cigarette and vapor nicotine delivery area. The development and prevalence of e-cigarettes has increased substantially in the last few years, as seen by the increased sales of e-cigarette throughout the country. Not surprisingly, use of e-cigarettes and other devices that deliver nicotine vapor are becoming more and more common amongst adolescents. Regardless of the prohibition on the sale of these nicotine delivery devices to people under 18 years of age, adolescents are continuing to initiate use of these products. Marketed as a harm reduction approach for adults, e-cigarettes are nevertheless sold containing e-liquid (which is heated to produce the nicotine vapor) with a variety of nicotine concentrations and flavorings that appeal strongly to youth.

The best accepted animal model for drug abuse is self-administration, in which animals are trained to perform an action that leads to drug administration. Animals will self-administer many drugs, and the degree of self-administration is a measure of abuse liability. The extent to which an animal will work to obtain drug is a measure of its motivation for the drug, and is a measure of drug craving or drug reward seeking behavior, an important aspect of the addictive process of humans.

However, a common means of animal drug vapor administration involves the delivery of drug vapor to the animal in a non-contingent manner (e.g., non-purposeful, non-volitional, or non-intentional) Using this technique, animals are continually exposed to vapor containing a study chemical, and later evaluated for behavioral and other physiological changes. The present inventor submits that it has been shown, self-administration of a drug differs significantly from the passive administration of the same drug, an aspect of an embodiment of the present invention technique that significantly advances the state of the art. The present inventor submits that volitional control over drug taking significantly enhances the development of synaptic plasticity, when compared to passive administration. This plasticity then drives behavioral changes that modulate further escalation of drug seeking, dependence, and withdrawal. As a result, the present inventor submits that involvement of drug self-administration is highly desirable as part of a model system that attempts to recapitulate drug usage in humans.

A common means of drug self-administration in animal models is via an in dwelling catheter implanted into the jugular, or other vein. This method requires difficult surgery, including anesthesia, and involves some degree of suffering to the animal. While commonly used in primates, and feasible in large rodents such as rats, intravenous drug self-administration is difficult in smaller rodents such as the genetically tractable animal model, the mouse. Although techniques have been described for implantation of intravenous catheters in the mouse, and such methods are used in animal experimentation, their utility is limited, since the catheters cannot be extended into the heart without severe tissue damage. Thus the intravenous catheters become blocked within a period of a few days after implantation, limiting the extent to which an individual animal can be studied.

For evaluation of nicotine, intravenous nicotine self-administration is possible to conduct in mice, as a way to approximate the conditioned exposure of adolescents to nicotine. However there are many drawbacks that an aspect of an embodiment of the current invention avoids. The present inventor submits that a vapor based drug delivery method and system provides the most direct and physiologically relevant method of evaluating drugs. This is along with the avoidance of all of the drawbacks listed above. Additionally, the present inventor submits that it would be difficult to investigate the role of flavorings in driving operant responding by intravenous self-administration of nicotine. The present inventor submits that vapor-based flavor delivery provides the most direct, physiologically relevant method of testing the role of gustation and olfaction in driving responding. The present inventor submits that the vapor self-administration model is more advantageous to use than an intravenous delivery method.

There have been some attempts to create a system for self-administration of a drug to an animal, but all do not contain the advantages of the current invention. Drawbacks of the prior art include a lack of remoteness between the area for initiating the self-administration of the drug and the location of administration of the drug, aversion animals have to being sprayed or spritzed with a drug, physiological question on the actual drug reward seeking behavior of the animal due to the conditioning of the animal with the drug with another substance (e.g., food, sugar), and precise control over the amount of drug being delivered to the animal so that a dose of the drug can be delivered and consumed by the animal that would be equivalent to a dose of the drug delivered and consumed by a human. These drawbacks leads to lower validity of the evaluation of a drug including the drug reward seeking behavior of the animal. Drawbacks of the prior art are overcome by the current invention.

### OVERVIEW

There are many benefits to an aspect of an embodiment of the current invention. An aspect of an embodiment of the current invention provides greater face, construct and content validity for a model for agent exposure than the current state of the art. An aspect of an embodiment of the current invention provides self-admiration of an agent to an animal wherein the animal has volitional or purposeful control of the administration of the agent to itself. There is no conditioning of the agent with food or another substance (e.g., sugar, sucrose) that allows for more direct evaluation of the drug reward seeking behavior in the animal. The amount of the agent provided to the animal may be precisely controlled. The precise control of the amount of agent provided may allow for the animal to be exposed to the same dose as a human on a per weight basis, which gives more validity to a test result. The remoteness of the sensor and the location where an agent is consumed by an animal allows for more accurate evaluation of the drug reward seeking behavior in the animal. The remoteness of the sensor and the location where an agent is consumed by the animal also avoid the drawback of the animal being sprayed or spritzed by a composition including the agent. Many animals, including mice, have an aversion to being sprayed or spritzed. This aversion decreases the accuracy of the evaluation of the drug reward seeking behavior in the animal.

There are many benefits to an aspect of an embodiment of the current invention in addition to the benefits listed above. An aspect of an embodiment of the present invention allows, but not limited thereto, the animal to control the delivery of drug vapor, permitting the animal to self-regulate vapor dosing, producing a model of drug exposure that possesses greater face, construct, and content validity than the current state of the art. For example, with respect to face validity, an aspect of an embodiment of the present invention more closely models the human condition of e-cigarette smoking, as humans actively control the delivery of nicotine vapor. With respect to construct validity, the present inventors observe responses from the tested animals that are similar to those animals trained to seek drugs supplied intravenously. Finally, with respect to content validity, the present inventors ability to demonstrate that the animals respond selectively for the vapor is related to a method for the assessment of drug seeking behavior. Importantly, none of the currently available state of the art techniques for the investigation of drug vapor seeking permit the same level of face, content or construct validity when compared to an aspect of an embodiment of the present invention.

An aspect of an embodiment of the current invention may be used in a variety of different ways to meet a variety of different goals in addition to those listed above. An aspect of an embodiment of the current invention may be used in designing a regulatory scheme for a drug or substance. An aspect of an embodiment of the current invention may be used in investigating how dosage of a drug drives responding for the drug in humans in the physiological form the drug is consumed in by humans, in determining whether the abuse potential of a drug is greater in adolescents than adults, and in determining how the use of a drug in adolescents affects the drug reward seeking behavior in adults. An aspect of an embodiment of the current invention may be used in investigating drug abuse and rehabilitation. An aspect of an embodiment of the current invention may be used in evaluating addiction behavior of animals that may shed light on addiction behavior in humans.

An aspect of an embodiment of the present invention may provide, but not limited thereto, a system for self-administration of an agent to an animal. The system may comprise: an enclosure for the confinement of an animal; a sensor that produces a signal when purposefully activated by the animal in the enclosure, wherein the purposefully activation defines a first behavior of the animal that is located at a first behavior location; and an agent dispenser that is configured to provide the agent in the enclosure in response to the sensor being purposely activated, wherein the agent is provided remotely from the first behavior location so as to require the animal to travel to the remotely provided agent at a remote provision location, wherein the traveling defines a second behavior of the animal.

An aspect of an embodiment of the present invention may provide, but not limited thereto, a method for self-administering an agent to an animal. The method may comprise: providing the animal in an enclosure; allowing the animal to purposefully activate a sensor from the enclosure, wherein the purposeful activation defines a first behavior of the animal that is located at a first behavior location; sending a signal from the sensor when purposefully activated by the animal; and providing the agent in the enclosure in response to the signal, wherein the agent is provided remotely from the first behavior location so as to require the animal to travel to the remotely provided agent at a remote provision location, wherein the traveling defines a second behavior of the animal.

Moreover, an aspect of an embodiment may provide a method of evaluating an agent in an animal, which may include: placing the animal in an agent evaluating system for self-administration of an agent to the animal; allowing the animal to acquire an agent-operant behavior by utilizing the system for self-administration of an agent to the animal; and appraising the animal of physical and/or mental effects of the acquisition of the agent operant behavior.

Moreover, an aspect of an embodiment may provide a method of evaluating an agent in an animal, which may include: placing the animal in an agent evaluating system for self-administration; allowing the animal to operantly condition itself between a purposeful activation action and a providing of the agent to the system for self-administration; and appraising at least one effect of the animal due to the agent.

Moreover, an aspect of an embodiment may provide a method of evaluating an agent in an animal, which may include: placing the animal in an agent evaluating system comprising a system for self-administration; allowing the animal to become reliant upon the agent by the animal self-administering the agent to itself by utilizing the system for self-administration; and appraising at least one effect of the animal due to the animal used to be or is reliant on the agent.

An aspect of an embodiment of the present invention may provide, but not limited thereto, a system for self-administering an agent to an animal further comprising an agent for use with the agent dispenser.

A system and related methods thereof involving self-administration of an agent to an animal. In certain embodiments, the system comprises an enclosure for the confinement of an animal; a sensor that produces a signal when purposefully activated by the animal in said enclosure, wherein the purposefully activation defines a first behavior of the animal that is located at a first behavior location; and an agent dispenser that is configured to provide the agent in the enclosure in response to the sensor being purposefully activated, wherein the agent is provided remotely from the first behavior location so as to require the animal to travel to the remotely provided agent at a remote provision location, wherein the traveling defines a second behavior of the animal. The system and related methods thereof can be used to provide a model system to evaluate the behavioral and/or physiological response(s) to a self-administered agent.

These and other objects, along with advantages and features of various aspects of embodiments of the invention disclosed herein, will be made more apparent from the description, drawings and claims that follow.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings

The accompanying drawings, which are incorporated into and form a part of the instant specification, illustrate several aspects and embodiments of the present invention and, together with the description herein, serve to explain the principles of the invention.

The drawings are provided only for the purpose of illustrating select embodiments of the invention and are not to be construed as limiting the invention.

FIG. 1 schematically represents an aspect of an embodiment of a system and related method for self-administrating an agent to an animal.

FIG. 2 schematically represents an aspect of an embodiment of a system and related method for self-administration of an agent to an animal.

FIG. 3 schematically represents an aspect of an embodiment of a system and related method for self-administration of an agent to an animal.

### DETAILED DESCRIPTION OF EXEMPLARY EMBODIMENTS

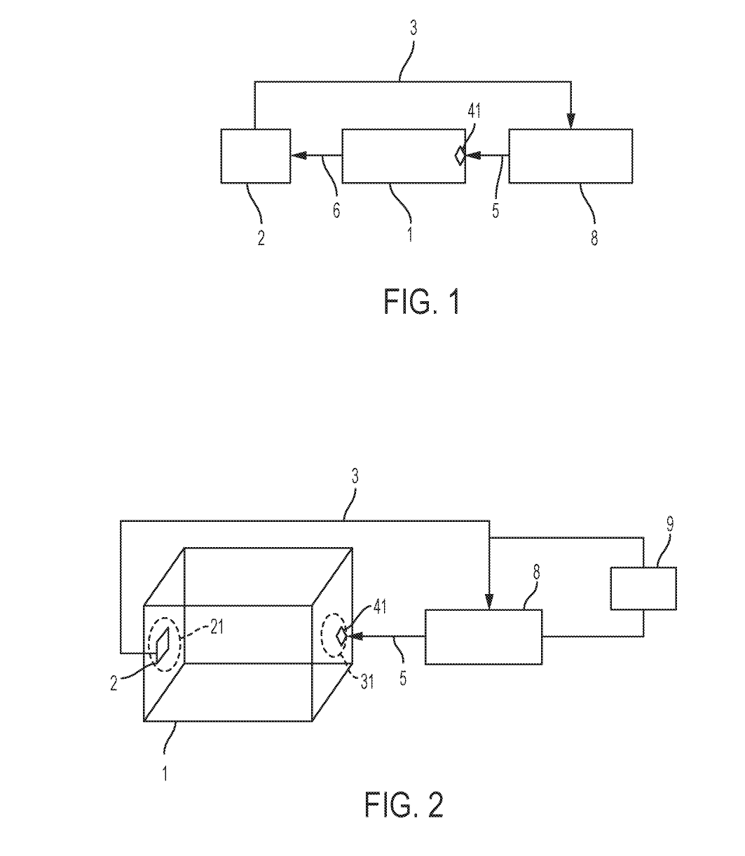

FIG. 1 schematically represents an aspect of an embodiment of a system and related method for self-administrating an agent to an animal (not shown) which allows for evaluating an agent. The system may comprise an enclosure 1 wherein a sensor 2 produces a signal 3 upon purposeful activation of sensor 6 by an animal within the enclosure 1. The signal 3 goes to an agent dispenser 8. The agent provided to or in the enclosure 5 comes from the agent dispenser 8 in response to signal 3. The agent provided to or in the enclosure 5 is available to be consumed by the animal or otherwise enter the body of the animal in the enclosure 1. In an approach, the enclosure 1 is provided for the confinement of an animal. The sensor 2 produces a signal 3 when purposefully activated (as generally shown by arrow, 6) by the animal in the enclosure 1, wherein the purposeful activation 6 defines a first behavior of the animal that is located at a first behavior location (generally defined as a location at or proximal to the sensor). The agent dispenser 8 provides the agent 41 in the enclosure 1 in response to the sensor 2 being purposely activated by the animal, wherein the agent 41 is provided remotely from the first behavior location so as to require the animal to travel to the remotely provided agent 41. The remote provision location is located a distance from the first behavior location so as to require the animal to travel to the remotely provided agent 41, wherein the traveling defines a second behavior of the animal.

FIG. 2 schematically represents an aspect of an embodiment of a system and related method for self-administration of an agent to an animal. The system may comprise an enclosure 1. A sensor 2 is able to be activated by a behavior of the animal in the enclosure 1. Upon activation, sensor 2 produces a signal 3 that is received by agent dispenser 8. Alternatively, a controller 9 may receive the signal 3 before the agent dispenser 8 receives the signal 3. Alternatively, the controller 9 may be in communication with the agent dispenser 8 alone or in conjunction with the controller 9 receiving the signal 3 before agent dispenser 8 receives the signal. The controller 9 may or not be present in the system represented in FIG. 2. The agent provided to or in the enclosure 5 comes from the agent dispenser 8 in response to signal 3 either directly or through the controller 9. In an approach, the enclosure 1 is provided for the confinement of an animal. The sensor 2 produces a signal 3 when purposefully activated by the animal in the enclosure 1, wherein the purposeful activation defines a first behavior of the animal that is located at a first behavior location 21, which is a location at or proximal to the sensor 2. The agent dispenser 8 provides 5 the agent 41 in the enclosure 1 in response to the sensor 2 being purposely activated by the animal, wherein the agent 41 is provided remotely at the remote provision location 31. The remote provision location 31 is located a distance from the first behavior location 21 so as to require the animal to travel to the remotely provided agent 41, wherein the traveling defines a second behavior of the animal.

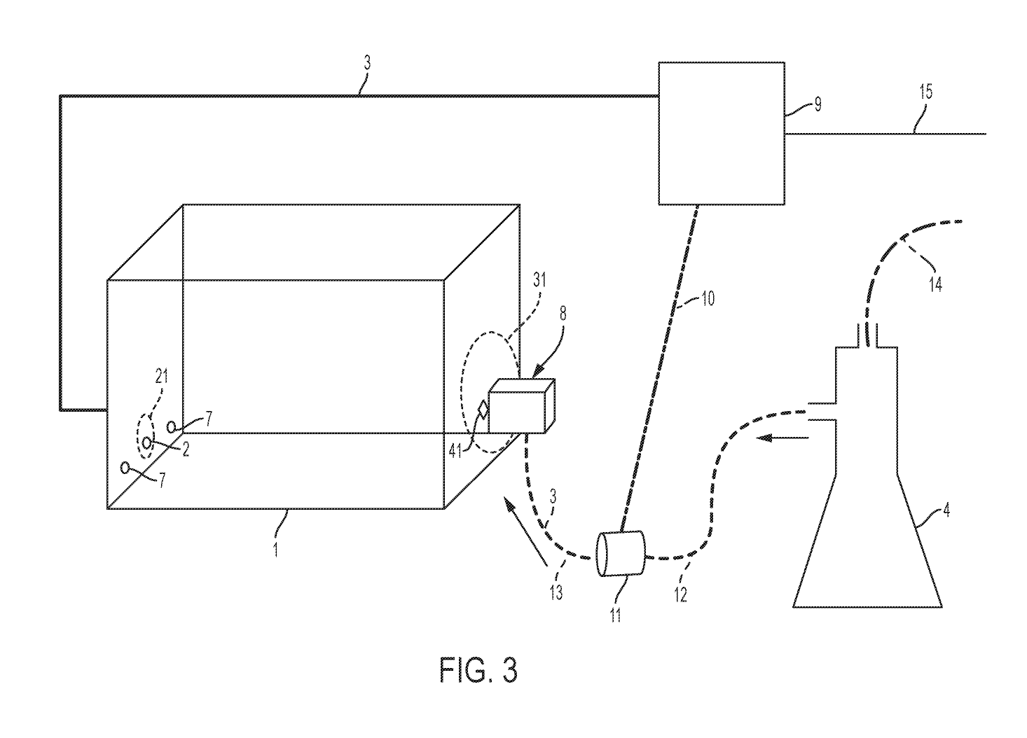

FIG. 3 schematically represents an aspect of an embodiment of a system and related method for self-administration of an agent to an animal. The system may comprise an enclosure 1 that can enclose an animal equipped with a sensor 2 and two pseudo sensors 7. Alternatively, there may be one pseudo sensor 7. Alternatively there may be a plurality of pseudo sensors 7. Sensor 2 produces a signal 3 when purposefully activated by the animal in the enclosure. The signal 3 is received by a controller 9. The controller 9 sends a communication 10 to a valve or switch 11 based upon signal 3 and/or device communication 15. The device communication 15 may control the controller 9, receive data from the controller 9 to be used for example to be displayed as a chart or graph or downloaded for analysis, provided to a computer, tablet, processor, and the like. The communication 10 may dictate whether valve or switch 11 is open or closed. If valve or switch 11 is open, agent is provided to the enclosure 1 from an agent supply 4, which may be pressurized from the pressure input 14, through a supply conduit 12, 13. If the valve or switch 11 is closed, agent is not provided to the enclosure 1. An agent dispenser 8 receives agent from supply conduit 13, assuming valve or switch 11 is open and provides the agent to the enclosure 1. In an approach, the enclosure 1 is provided for the confinement of an animal. The sensor 2 produces a signal 3 when purposefully activated by the animal in the enclosure 1, wherein the purposeful activation defines a first behavior of the animal that is located at a first behavior location 21, which is a location at or proximal to the sensor 2. The agent dispenser 8 provides the agent 41 in the enclosure 1 in response to the sensor 2 being purposely activated by the animal, wherein the agent 41 is provided remotely at the remote provision location 31. The remote provision location 31 is located a distance from the first behavior location 21 so as to require the animal to travel to the remotely provided agent 41, wherein the traveling defines a second behavior of the animal.

An aspect of an embodiment of the invention includes a system for a self-administration of an agent to an animal. First, the system may include an enclosure for the confinement of an animal. The animal may be any living organism other than a human being. The animal may be a mouse, rat, or other mammal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to human (e.g. rat, dog, pig, monkey), etc. The enclosure may be an area that is sealed off with an artificial or natural barrier or container. Second, the system may include a sensor that produces a signal when purposefully activated by the animal in the enclosure, wherein the purposeful activation defines a first behavior of the animal that is located at a first behavior location. The sensor may be any type of sensor including a pressure sensor, including a weight sensor, optical sensor, force sensor, and acoustic sensor. The sensor may be a nosepoke hole sensor, which is a type of force or pressure sensor. The purposeful activation of the sensor by the animal is done out the volition or intention of the animal. The system may include at least one, if not more, pseudo sensor that is of the same or different activation type as the sensor and does not provide agent to the enclosure. Third the system may include an agent dispenser that is configured to provide the agent in the enclosure in response to the sensor being purposely activated, wherein the agent is provided remotely from the first behavior location so as to require the animal to travel to the remotely provided agent at a remote provision location, wherein the traveling defines a second behavior of the animal. The agent provided to the enclosure may be any substance including drugs, pharmaceuticals, biologics, and the like. The agent may be cigarette smoke, electronic cigarette smoke, cannabis smoke, crack cocaine smoke, nicotine, flavoring, methanol, and the like. The agent may be in any state of matter including solid, liquid, gas, vapor, aerosol, and the like. The system may include an agent supply that may be in material communication with the agent dispenser. The agent supply may prepare or condition the agent as needed so that when the agent is provided to the enclosure, the agent possesses acceptable physical characteristics such as state of matter, temperature, pressure, composition, size, and the like. The preparation or conditioning of the agent may including heating, cooling, mixing, agitating, settling, pressurizing, depressurizing, diminishing the size of particle(s), increasing size of particle(s), changing state of matter, creating the agent from at least one substance, and the like. The agent supply may include an agent chamber for containing the agent, a heating source that gives heat to the agent chamber, and/or a pressurization source for pressurizing the agent. The agent supply may include a conduit that fluidically couples an agent chamber for containing the agent and/or a valve interposed between an agent chamber for containing the agent dispenser within a conduit fluidically coupling the agent chamber and the agent dispenser wherein the valve is operable to control the providing of the agent in the enclosure based on the signal from the sensor. The valve may be any mechanism configured for regulating fluid or agent flow.

An aspect of an embodiment of the invention includes a method for self-administering an agent to an animal. First, the method may include providing an animal is provided to an enclosure. The animal may be any living organism other than a human being. The animal may be a mouse, rat, or other mammal. The enclosure may be an area that is sealed off with an artificial or natural barrier or container. Second, the method may include the animal to purposefully activate a sensor from the enclosure, wherein the purposeful activation defines a first behavior of the animal that is located at a first behavior location. The sensor may be any type of sensor including a pressure sensor, including a weight sensor, optical sensor, force sensor, and acoustic sensor. The sensor may be a nosepoke hole sensor, which is a type of force or pressure sensor. The purposeful activation of the sensor by the animal is done out the volition or intention of the animal. Third, the method may include sending a signal from the sensor when the sensor is purposefully activated by the animal. Fourth, the method may include providing the agent in the enclosure in response to the signal, wherein the agent is provided remotely from the first behavior location so as to require the animal to travel to the remotely provided agent, wherein the traveling defines a second behavior of the animal. The agent provided to the enclosure may be any substance including drugs, pharmaceuticals, biologics, and the like. The agent may be cigarette smoke, electronic cigarette smoke, cannabis smoke, crack cocaine smoke, nicotine, flavoring, methanol, and the like. The agent may be in any state of matter including solid, liquid, gas, vapor, aerosol, and the like. The agent may be nicotine wherein 1.5-2 ug of nicotine is provided to the enclosure. The agent provided to the enclosure may be prepared or conditioned in any way so that the agent may be provided to the enclosure. The agent may be prepared or conditioned by heating the agent, cooling the agent, pressurizing the agent, depressurizing the agent, changing the size of agent particle(s), volatizing the agent, agitating the agent, settling the agent, changing the state of matter of the agent, creating the agent from at least one substance, and the like. The method for self-administering an agent to an animal may further comprise controlling the agent being provided into the enclosure based on the signal from the sensor. The controlling may be done in any way known to one of ordinary skill in the art. The controlling may be done by a computer, controller, data processing machine, and the like. The controlling may be done through fixed ratio responding, progressive ratio responding, or any other type of controlling.

An aspect of an embodiment of the invention may include a method of evaluating an agent in an animal. First, the method may include placing the animal in an agent evaluating system comprising a system for self-administration of an agent to an animal described within this disclosure. Second, the method may include allowing the animal to acquire an agent-operant behavior by utilizing the system for self-administration of an agent to an animal described within this disclosure. Third, the method may include appraising the animal of physical and/or mental effects of the acquisition of the agent operant behavior. The operant behavior may be nosepoking into a particular nosepoke hole, pressing of a lever, moving to particular area of the enclosure, making a noise, standing or moving in a particular area of the enclosure, and the like. The agent may be any substance including drugs, pharmaceuticals, biologics, and the like. The agent may be cigarette smoke, electronic cigarette smoke, cannabis smoke, crack cocaine smoke, nicotine, flavoring, methanol, and the like. The agent may be in any state of matter including solid, liquid, gas, vapor, aerosol, and the like. The step of appraising the animal may include, but not limited thereto, fixed ratio testing, progressive ratio test, agent conditioned place preference test, withdrawal behavior test, elevated plus maze test, somatic withdrawal test, hyperalgesia test, agent receptor ligand binding in brain tissue test, proteomic test of changes in agent receptor, and proteomic test of key protein expression in a brain of an chronic treated animal; as well as any other analyzing or testing options that, but not limited thereto, are available in the field or disclosed in the below Section designated as the Example and Experimental Set Nos. 1 and 2.

An aspect of an embodiment of the invention may include a method of evaluating an agent in an animal. First, the method may include placing the animal in an agent evaluating system comprising a system for self-administration described within this disclosure. Second, the method may include allowing the animal to operantly condition itself between a purposeful activation action and a providing of the agent to the system for self-administration described within this disclosure. Third, the method may include appraising at least one effect of the animal due to the agent. The agent may be any substance including drugs, pharmaceuticals, biologics, and the like. The agent may be cigarette smoke, electronic cigarette smoke, cannabis smoke, crack cocaine smoke, nicotine, flavoring, methanol, and the like. The agent may be in any state of matter including solid, liquid, gas, vapor, aerosol, and the like. The step of appraising the animal may include, but not limited thereto, fixed ratio testing, progressive ratio test, agent conditioned place preference test, withdrawal behavior test, elevated plus maze test, somatic withdrawal test, hyperalgesia test, agent receptor ligand binding in brain tissue test, proteomic test of changes in agent receptor, and proteomic test of key protein expression in a brain of an chronic treated animal; as well as any other analyzing or testing options that, but not limited thereto, are available in the field or disclosed in the below Section designated as the Example and Experimental Set Nos. 1 and 2.

An aspect of an embodiment of the invention may include a method of evaluating an agent in an animal. First, the method may include placing the animal in an agent evaluating system comprising a system for self-administration described within this disclosure. Second, the method may include allowing the animal to become reliant upon the agent by the animal self-administering the agent to itself by utilizing the system for self-administration of described within this disclosure. Third, the method may include appraising at least one effect of the animal due to the animal used to be or is reliant on the agent. The agent may be any substance including drugs, pharmaceuticals, biologics, and the like. The agent may be cigarette smoke, electronic cigarette smoke, cannabis smoke, crack cocaine smoke, nicotine, flavoring, methanol, and the like. The agent may be in any state of matter including solid, liquid, gas, vapor, aerosol, and the like. The step of appraising the animal may include, but not limited thereto, fixed ratio testing, progressive ratio test, agent conditioned place preference test, withdrawal behavior test, elevated plus maze test, somatic withdrawal test, hyperalgesia test, agent receptor ligand binding in brain tissue test, proteomic test of changes in agent receptor, and proteomic test of key protein expression in a brain of an chronic treated animal; as well as any other analyzing or testing options that, but not limited thereto, are available in the field or disclosed in the below Section designated as the Example and Experimental Set Nos. 1 and 2.

It should be appreciated that the system or any related system components, such as for example, the enclosure, sensing components, and dispensing components can take on all shapes and contours (and required sizes) along the entire continual geometric spectrum of manipulation of x, y and z planes to provide and meet the anatomical and structural demands, operational and requirements.

### EXAMPLES

Practice of an aspect of an embodiment (or embodiments) of the invention will be still more fully understood from the following examples and experimental results, which are presented herein for illustration only and should not be construed as limiting the invention in any way.

### Example and Experimental Results Set No. 1

All mice will have access to operant chambers (MED-307W-B2, Med Associates, VT) enclosed in MDF sound and light attenuating chambers for 1 hour daily. These chambers have 3 nosepoke holes located on the chamber wall opposite to a magazine that houses the nicotine vapor input line. Outside the chamber, 5 ml of nicotine liquid (80% glycerol (with/without 5% flavoring) 20% water) will be heated to near boiling (115° C.) on a hotplate and pressurized in a 100 ml pyrex flask using breathing air from a compressed gas cylinder.

With respect to the description of tubing and vapor flow, pressurized air is routed through a ⅜″ internal diameter (ID) flexible hose, stepped down to a ¼″ ID hose then attached to a 100 ml pyrex flask capped with a GL 45 screw cap top. The top is modified such that two ¼″ flexible tubing connectors have been inserted, allowing tubing to be connected forming a gas inlet and outlet from the flask. The ¼″ outlet is connected to 12″ of ¼″ ID flexible tubing that connects to an ASCO 24V DC normally closed solenoid (cat #U8256A2V). The solenoid receives electrical input from the med associates operant chamber SmartCtrl© output board. The vapor outlet of the solenoid is connected to 12″ of ¼″ ID tubing that is then stepped down to 12″ of ⅛″ ID tubing. The outlet of this tubing is then inserted into the side of the Med associates pellet receptacle (med associates part #ENV-303W).

In this arrangement, nosepoking in the center nosepoke hole will result in a 2 second illumination of the nosepoke light and a 10 second, 28V DC pulse delivered from the operant box SmartCtrl© output panel. The voltage is stepped down to 24V DC using a rheostat and is then delivered to the solenoid. The voltage pulse opens the solenoid for 10 seconds, allowing nicotine vapor (delivered at a rate of 1.5 L per minute, calibrated using an air flow meter) into the chamber. The present inventor's preliminary data has shown that 10 pulses of vapor deliver 1.5-2 ug of nicotine (from a 10 mg/ml nicotine solution), a dose similar to that delivered from an e-cigarette (on a per weight basis) in humans. Nosepokes on the left and right nosepoke holes will not result in vapor delivery but will be counted. Vapor will not be actively scavenged but will diffuse out of the chamber and exhausted from the test room via room air ducts. Residual concentration of nicotine in room air during experimentation has been shown to be below the limits of detection by a sorbent tube—gas chromatography/mass spectrometry method (data not shown).

### Example and Experimental Results Set No. 2

### Overview

The present inventor has established the use of an operant vapor self-administration model for evaluating the effects of nicotine vapor on adolescent mice. This experiment will address three aims. In Aim 1, the present inventor will test whether adolescent males or females show more rapid initiation and higher levels of responding for nicotine vapor when compared to adults, as is suggested by the present inventor's preliminary data. The present inventor will also test whether the inclusion of flavorings enhances responding for these nicotine solutions, as suggested by prior work and by the present inventor's preliminary data. At the conclusion of these two sets of experiments, the present inventor will investigate how vapor exposure changes nicotinic receptor subunit expression levels (protein and membrane expressed) and how vapor exposure affects CREB phosphorylation in adult and adolescent animals to gain a better understanding of the mechanisms driving vapor intake. In Aim 2, the present inventor will investigate the ability of male and female, adult and adolescent mice to exhibit escalation of vapor intake and subsequently withdrawal following vapor abstinence, to determine whether a state of dependence may develop following chronic vapor exposure. Finally, in Aim 3, the present inventor will test whether adolescent male and female exposure to nicotine vapor modulates nicotine reward in adulthood, assayed using a test of nicotine conditioned place preference.

In summary, the present inventor presents experiments that provide important insight into the actions of nicotine vapor in adolescents, insight that will assist in developing strategies to reduce adolescent vapor usage.

### Animal Test Subjects

All proposed procedures have been approved by the University of Virginia institutional care and use committee. All mice will be housed in the Jordan Hall vivarium at the University of Virginia on a reversed 12 h light: 12 h dark cycle (lights-on at 6:00 pm unless stated otherwise) with free access to food and water. Mice will be purchased from Jackson labs (Bar Harbor, Me.). Based on the present inventor's preliminary data, the present inventor will require 15 mice for each of the 4 treatment groups: male adolescent, female adolescent, male adult and female adult. These numbers are based on the present inventor's power analysis and on empirical evidence that the present inventor has obtained from the present inventor's preliminary studies on vapor self administration. For example, the present inventor anticipates that between 50 and 75% of all animals will acquire vapor self-administration. All animals will be allowed to acclimatize to the vivarium for 1 week following arrival from Jackson Labs. Animals will also be handled daily for this first week prior to training. Use of the 4 groups will be repeated within each aim, as per their requirement for the conduct of each series of experiments.

Postnatal day (PND) 28 aged mice will be used for the adolescent animal studies, a time that corresponds well to early adolescence, physiologically and behaviorally, in humans. Studies will be conducted between early and late adolescence, between PND28 and PND57. Animals aged PND 70 will be used in the adult animal studies, a point at which developmental maturation has completed. Female testing will be coordinated such that testing begins in each experimental group during the same stage of the estrus cycle, as described below

### Vapor Self-Administration

At PND 28, adolescent animals will begin operant training. Adult animals, meanwhile, will begin training at PND 70. Adult female and adolescent mice will begin testing during diestrus, to ensure that any effect of hormone variation is equally distributed across each testing group.

All mice will have access to operant chambers (Med Associates, VT) enclosed in MDF sound and light attenuating chambers for 1 hour daily. These chambers have 3 nosepoke holes located on the chamber wall opposite to a magazine that houses the nicotine vapor input line. Outside the chamber, 5 ml of nicotine liquid (80% glycerol (with/without 5% flavoring) (20% water) will be heated to near boiling (115° C.) on a hot plate and pressurized in a 100 ml pyrex flask using breathing air from a compressed gas cylinder. The outlet of the flask downstream of the air cylinder is connected to a normally closed solenoid, preventing vapor delivery to the operant chamber. Nosepoking in the center nosepoke hole will result in a 2 second illumination of the nosepoke light and a 10 second pulse of nicotine vapor (delivered at a rate of 1.5 L per minute into the chamber). The present inventor's preliminary data has shown that 10 pulses of vapor deliver 1.5-2 ug of nicotine from a 10/mg/ml nicotine solution), a dose similar to that delivered from an e-cigarette (on a per weight basis) in humans. Nosepokes on the left and right nosepoke holes will not result in vapor delivery but will be counted. Vapor will not be actively scavenged but will diffuse out of the chamber and exhausted from the test room via room air ducts. Residual concentration of nicotine in room air during experimentation has been shown to be below the limits of detection by a sorbent tube—gas chromatography/mass spectrometry method.

Mice will be tested for their time to acquisition of fixed ratio (FR) responding, defined as the ability to discriminate between the center and peripheral left/right nosepoke holes. Acquisition will be achieved when mice perform 10 active nosepokes during the trial, with the active nosepoke numbers being twice that observed on any inactive nosepoke hole, observable on 2 consecutive days of testing. The present inventor anticipates that mice will require between 5 to 10 days to acquire responding, based on the present inventor's preliminary data. This acquisition criteria is similar to that reported for operant intravenous nicotine paradigm.

Following acquisition, testing will continue for 5 days and the numbers of nicotine vapor pulses recorded. For adult female and adolescent animals, the responding during the 5 days will also be analyzed for any effect of estrus cycle stage on nosepoking behavior. At the end of the 5 day period, mice will undergo a progressive ratio (PR) test to examine motivation to obtain vapor reward. In the progressive ratio test, animals will nosepoke for vapor with each reinforcement requiring a progressively greater number of nosepokes. The ratio will increase according to the sequence: 1, 2, 4, 6, 9, 12, 15, 20, 25, 32. Similar to that described for use in an intravenous self-administration paradigm. The progressive ratio experiment will last for a maximum of six hours with the experiment also terminating after 1 hour in the absence of ratio completion. The final ratio achieved will be considered the breakpoint.

### Nicotine Conditioned Place Preference

In order to determine whether adolescent exposure to nicotine affects the perception of nicotine reward later on in life, following vapor exposure, mice will be kept group housed until PND70. Again, all female animals will begin testing at the onset of diestrus to minimize assay variability between subjects. At this time point, mice will be singly housed for 1 week then tested for the induction of place preference for nicotine. Nicotine will be injected subcutaneously at either of 4 concentrations: 0.01 mg/kg, 0.1 mg/kg, 0.5 mg/kg and 1 mg/kg. Briefly, a 2-chamber place conditioning apparatus (20 cm×20 cm×20 cm) will be used, with a divider to partition the chambers during conditioning. At PND70, animals will be handled once per day for 2 minutes on 3 subsequent days (Wednesday to Friday) on the week prior to conditioning. On day 1 of the experiment, mice will undergo a preconditioning phase, where animals will be allowed to explore both chambers freely for 15 minutes, with the time spent in either chamber counted. This data will then be used to determine nicotine and saline side pairing, to ensure assignment of animals to treatment groups with minimal net side bias. Animals will then be injected either with nicotine on one chamber side and saline on the other or will be injected with saline on both chamber sides. Following each injection, mice will be allowed to explore the chamber for 20 minutes. Drug paired sides will be randomized amongst the group animals. Conditioning will be performed for 3 consecutive days. On day five of the experiment, animals will not receive injections but will be allowed to explore both chambers as was performed during the pre-test. Time spent on either side of the apparatus will be scored. Place preference will be determined by subtracting the amount of time spent on the saline-paired side from the time spent on the nicotine-paired side. A positive score will demonstrate a place preference for the drug.

### Assessment of Withdrawal Behavior

Both the physical and affective signs of withdrawal will be tested. Briefly, the non-selective nicotinic antagonist, mecamylamine will be used to precipitate nicotine withdrawal, given at a dose of 2 mg/kg. Control animals will be given saline to examine withdrawal in the absence of nicotinic receptor blockade. Signs of withdrawal will be measured 10 minutes following injection. The initial test will be to determine whether anxiety like behavior in an elevated plus maze test is altered following vapor exposure. Following anxiety testing, mice will be examined for somatic withdrawal signs for 20 minutes and then immediately tested for the development of hyperalgesia.

### Elevated Plus Maze

The elevated plus maze is composed of 2 arms without sides measuring 23 cm long×6 cm wide and 2 arms with plexiglass sides measuring 23 cm long×6 cm wid×15 cm tall. Arms are connected to a central 5cm x 5cm central area. The maze will be elevated above the floor to a height of 60 cm. Light will be provided by an overhead fluorescent light (300 lux). At the start of testing, animals will be placed in the center of the arena and allowed to explore the apparatus freely. The location of the mouse will be recorded for 5 minutes using Noldus 7 video tracking software and a top mounted CCD camera. Amount of time spent in the open arms and the amount of time spent in the closed arm area will be extracted. A decrease in the amount of time spent in the open arms is indicative of elevated anxiety-like behavior, when compared to controls. The number of crosses between each arm will also be recorded, as a measure of locomotor activity.

### Somatic Withdrawal Assessment

Following elevated plus maze testing, mice will be subjected to analysis for signs of somatic withdrawal. Animals will be placed in a transparent plexiglass cage (32/18 cm) and withdrawal signs measured. Behavior will be recorded and scored by blind observers. Behaviors that will be scored will include head shakes, paw tremors, body tremors and backing. Ptosis and jumping behavior will be counted together as “other” somatic withdrawal signs. Results will be reported as the number of signs displayed during the 20 minute observation period.

### Test of Hyperalgesia

Hyperalgesia during withdrawal will be measured using a hot plate test. The apparatus will consist of a hot plate, maintained at 52° C., surrounded by plexiglass. A timer will be used to assess the expression of nociception signs, including jumping and paw licks. Testing will last for 40 seconds, to avoid harming the mouse.

Assessment will again be performed by a blinded observer. In this test, a decreased latency to exhibit signs of pain will be used to indicate increased pain sensitivity or hyperalgesia.

### Measurement of Nicotinic Receptor Ligand Binding in Brain Tissue of Mice

Membrane fractions will be prepared from mouse brain. Frozen tissue will be maintained at −80° C. and thawed on ice for each assay. Tissue will be homogenized on ice in 10 volumes of a cold lysis buffer (50 mM Tris HCl, pH 7.4, containing protease inhibitor cocktail from Roche) using a Polytron homogenizer (settings: 6 pulses at 10 seconds/pulse). The homogenate will be centrifuged at 1,000×g for 10 min at 4° C. and the supernatant will be centrifuged at 40,000×g for 30 min at 4° C. The pellet will be suspended in the same lysis buffer as above and subject to another round of homogenization and centrifugation at the same settings as above. The final pellet will be used for the saturation binding assay.

Radioligand binding assays of nAChRs to [3H]-epibatidine in mouse brain tissue will be performed by incubating with [3H]-epibatidine the tissue for 4 h at room temperature. Nonspecific binding is assessed in parallel in the presence of 300 □M nicotine. Bound and free ligands will be separated by vacuum filtration through Whatman GF/C filters treated with 0.5% polyethylenimine. The filter-retained radioactivity will be measured by liquid scintillation counting. Specific binding is defined as the difference between total binding and nonspecific binding.

### Proteomic Analysis of Changes in Nicotine Receptor and Key Protein Expression in the Brain of Chronic Treated Mice

The effect of flavorings, nature of nicotine vapor exposure, age and sex on changes in β2, α4 nicotinic receptor subunits in the brain will be performed using Western blot analysis. The prefrontal cortex, nucleus accumbens and ventral tegmental area (VTA) will be dissected in an ice-cold dissection buffer (HBSS supplemented with 10 mM HEPES) then transferred into cold homogenization buffer [0.32 M sucrose, 10 mM HEPES, 2 mM EDTA, pH 7.4 supplemented with a protease and phosphatase inhibitor cocktail (Roche)]. The tissue will be homogenized using a glass dounce homogenizer on ice for 10-15 strokes and the homogenate centrifuged for 15 min at 1000×g at 4° C. Membrane proteins will be isolated by spinning the supernatant for 45 min at 200,000×g at 4° C. then suspending the pellet in a lysis buffer solution consisting of 50 mM HEPES, 2 mM EDTA, pH 7.4, supplemented with the protease phosphatase inhibitor cocktail (Roche). Proteins will be solubilized by gentle mixing in the above lysis solution at 4° C. for 1 hour.

Western blot detection of β2, α4 nicotinic receptor subunits along with CREB and phosphoCREB from the membrane fraction will utilize the following primary antibodies (Abs). These antibodies have been tested in pilot Western blot assays for the selective ability to detect the nAChR and CREB in cells (data not shown). In these preliminary experiments, cDNA for the β2, α4 subunits, was expressed in cultures of HEK 293 cells (CREB and phosphoCREB). Antibodies were analyzed for their capacity to detect the appropriate nAChR on the blot (using non-transfected cells as a control) along with CREB and phosphoCREB (specificity determined using a competing peptide). These antibodies are: polyclonal anti-β2 (Santa Cruz), polyclonal anti-α4 (Santa Cruz), Phospho-CREB (Ser133) (87G3) Rabbit mAb, CREB (48H2) Rabbit mAb #9197 (Cell Signaling Technology) A rabbit polyclonal anti-GAPDH antibody will be used as a loading control in the Western blot (Cell Signaling). Species-specific peroxidase conjugated secondary Abs are purchased from (Jackson-Immunoresearch). Protein bands are detected using the SuperSignal West Pico Chemiluminescent Substrate (Thermo Scientific). Blots will be imaged using the Gel Doc Imaging system (Bio-Rad). Band density analysis was performed using ImageJ version 10.2 (NIH). All samples were run in triplicates to obtain group averages.

### Additional Examples

### Example 1

A system for self-administration of an agent to an animal. The system comprising: an enclosure for the confinement of an animal; a sensor that produces a signal when purposefully activated by the animal in the enclosure, wherein the purposefully activation defines a first behavior of the animal that is located at a first behavior location; and an agent dispenser that is configured to provide the agent in the enclosure in response to the sensor being purposely activated, wherein the agent is provided remotely from the first behavior location so as to require the animal to travel to the remotely provided agent at a remote provision location, wherein the traveling defines a second behavior of the animal.

### Example 2

The system of example 1, wherein the agent dispenser is in material communication (e.g., fluidic communication if agent is a fluid) with an agent supply.

### Example 3

The system of example 2, wherein the agent supply further comprising: an agent chamber for containing the agent; a heating source that gives heat to the agent chamber; and a pressurization source for pressuring the agent.

### Example 4

The system of example 3, wherein the agent supply further comprising: a conduit that materially couples the agent chamber and the agent dispenser (e.g., fluidically couples if agent is a fluid); wherein a valve is interposed between the agent chamber and the agent dispenser within the conduit and is operable to control the providing of the agent in the enclosure based on the signal from the sensor.

### Example 5

The system of example 1, (as well as subject matter of one or more of any combination of examples 2-4), wherein the sensor is at least one of the following: pressure sensor, optical sensor, force sensor, or acoustic sensor.

### Example 6

The system of example 1, (as well as subject matter of one or more of any combination of examples 2-5), wherein the sensor is a nosepoke hole sensor.

### Example 7

The system of example 1, (as well as subject matter of one or more of any combination of examples 2-6), further comprising: at least one pseudo sensor that is of the same activation type as the sensor and does not provide the agent to the enclosure.

### Example 8

The system of example 1, (as well as subject matter of one or more of any combination of examples 2-7), wherein the agent dispenser is configured to provide at least one of the following into the enclosure: solid, liquid, gas, vapor, or aerosol.

### Example 9

The system of example 1, (as well as subject matter of one or more of any combination of examples 2-8), wherein the agent dispenser is configured to provide the agent wherein the agent is at least one of the following: cigarette smoke, electronic cigarette smoke, cannabis smoke, crack cocaine smoke, nicotine, flavoring, or methanol.

### Example 10

The system of example 1, (as well as subject matter of one or more of any combination of examples 2-9), wherein the agent dispenser is configured to provide the agent wherein the agent is at least one of the following: nicotine, flavoring, or methanol.

### Example 11

A method for self-administering an agent to an animal. The method comprising: providing the animal in an enclosure; allowing the animal to purposefully activate a sensor from the enclosure, wherein the purposeful activation defines a first behavior of the animal that is located at a first behavior location; sending a signal from the sensor when purposefully activated by the animal; and providing the agent in the enclosure in response to the signal, wherein the agent is provided remotely from the first behavior location so as to require the animal to travel to the remotely provided agent at a remote provision location, wherein the traveling defines a second behavior of the animal.

### Example 12

The method of example 11, wherein the agent is at least one of the following: cigarette smoke, electronic cigarette smoke, cannabis smoke, crack cocaine smoke, nicotine, flavoring, or methanol.

### Example 13

The method of example 11, (as well as subject matter of example 12), wherein the agent is at least one of the following: nicotine, flavoring, or methanol.

Example 14. The method of example 11, (as well as subject matter of one or more of any combination of examples 12-13), wherein the method further comprising: heating the agent; and pressurizing the agent.

### Example 15

The method of example 14, (as well as subject matter of one or more of any combination of examples 12-13), further comprising: controlling the agent being provided into the enclosure based on the signal from the sensor.

### Example 16

The method of example 11, (as well as subject matter of one or more of any combination of examples 12-15), further comprising: controlling the agent being provided into the enclosure based on the signal from the sensor.

### Example 17

The method of example 11 (as well as subject matter of one or more of any combination of examples 12-16), wherein the agent is nicotine and 1.5-2 ug of nicotine is provided to the enclosure when the sensor is purposefully activated.

### Example 18

A method of evaluating an agent in an animal (as well as subject matter of one or more of any combination of examples 1-17). The method comprising: placing the animal in an agent evaluating system comprising a system for self-administration of an agent to an animal of example 1; allowing the animal to acquire an agent-operant behavior by utilizing the system for self-administration of an agent to an animal of example 1; and appraising the animal of physical and/or mental effects of the acquisition of the agent operant behavior.

### Example 19

The method of example 18, wherein said agent is at least one of the following: cigarette smoke, electronic cigarette smoke, cannabis smoke, crack cocaine smoke, nicotine, flavoring, or methanol.

### Example 20

The method of example 18 or 19, wherein said step of appraising the animal is at least one of the following: fixed ratio testing, progressive ratio test, agent conditioned place preference test, withdrawal behavior test, elevated plus maze test, somatic withdrawal test, hyperalgesia test, agent receptor ligand binding in brain tissue test, proteomic test of changes in agent receptor, or proteomic test of key protein expression in a brain of an chronic treated animal.

### Example 21

A method of evaluating an agent in an animal, (as well as subject matter of one or more of any combination of examples 1-20). The method comprising: placing the animal in an agent evaluating system comprising a system for self-administration of example 1; allowing the animal to operantly condition itself between a purposeful activation action and a providing of the agent to the system for self-administration of example 1; and appraising at least one effect of the animal due to the agent.

### Example 22

The method of example 21, wherein said agent is at least one of the following: cigarette smoke, electronic cigarette smoke, cannabis smoke, crack cocaine smoke, nicotine, flavoring, or methanol.

### Example 23

The method of examples 21 or 22, wherein said step of appraising the animal is at least one of the following: fixed ratio testing, progressive ratio test, agent conditioned place preference test, withdrawal behavior test, elevated plus maze test, somatic withdrawal test, hyperalgesia test, agent receptor ligand binding in brain tissue test, proteomic test of changes in agent receptor, or proteomic test of key protein expression in a brain of an chronic treated animal.

### Example 24

A method of evaluating an agent in an animal, (as well as subject matter of one or more of any combination of examples 1-23. The method comprising: placing the animal in an agent evaluating system comprising a system for self-administration of example 1; allowing the animal to become reliant upon the agent by the animal self-administering the agent to itself by utilizing the system for self-administration of example 1; and appraising at least one effect of the animal due to the animal used to be or is reliant on the agent.

### Example 25

The method of example 24, wherein said agent is at least one of the following: cigarette smoke, electronic cigarette smoke, cannabis smoke, crack cocaine smoke, nicotine, flavoring, or methanol.

### Example 26

The method of examples 24 or 25, wherein said step of appraising the animal is at least one of the following: fixed ratio testing, progressive ratio test, agent conditioned place preference test, withdrawal behavior test, elevated plus maze test, somatic withdrawal test, hyperalgesia test, agent receptor ligand binding in brain tissue test, proteomic test of changes in agent receptor, or proteomic test of key protein expression in a brain of an chronic treated animal.

### Example 27

The system of claim 1, further comprising:

at least one agent for use with said agent dispenser and/or enclosure (and/or use with other components of said system).

### Example 28

The method of using any of the systems or its components provided in any one or more of examples 1-10 and 27.

### Example 29

The method of manufacturing any of the systems or its components provided in any one or more of examples 1-10 and 27.

### REFERENCES

The devices, systems, materials, agents, and methods of various embodiments of the invention disclosed herein may utilize aspects disclosed in the following references, applications, publications and patents and which are hereby incorporated by reference herein in their entirety (and which are not admitted to be prior art with respect to the present invention by inclusion in this section):
1. Schroeder M J, Hoffman A C. Electronic cigarettes and nicotine clinical pharmacology. Tobacco control. 2014; 23 Suppl doi: 10.1136/tobaccocontrol-2013-051469. PubMed PMID: 24732160; PubMed Central PMCID: PMC3995273.
2. Matta S G, Balfour D J, Benowitz N L, Boyd R T, Buccafusco J J, Caggiula A R, Craig C R, Collins A C, Damaj M I, Donny E C, Gardiner P S, Grady S R, Heberlein U, Leonard S S, Levin E D, Lukas R J, Markou A, Marks M J, McCallum S E, Parameswaran N, Perkins K A, Picciotto M R, Quik M, Rose J E, Rothenfluh A, Schafer W R, Stolerman I P, Tyndale R F, Wehner J M, Zirger J M. Guidelines on nicotine dose selection for in vivo research. Psychopharmacology (Berl). 2007; 190(3):269-319. Epub 2006/08/10. doi: 10.1007/s00213-006-0441-0. PubMed PMID: 16896961.
3. Saal D, Dong Y, Bonci A, Malenka R C. Drugs of abuse and stress trigger a common synaptic adaptation in dopamine neurons. Neuron. 2003; 37(4):577-82. PubMed PMID: 12597856.
4. Kenny P J, Markou A. Nicotine self-administration acutely activates brain reward systems and induces a long-lasting increase in reward sensitivity. Neuropsychopharmacology. 2006; 31(6):1203-11. Epub 2005/09/30. doi: 1300905 [pii]10.1038/sj.npp.1300905. PubMed PMID: 16192981.
5. Fowler C D, Kenny P J. Intravenous nicotine self-administration and cue-induced reinstatement in mice: effects of nicotine dose, rate of drug infusion and prior instrumental training. Neuropharmacology. 2011; 61(4):687-98. doi: 10.1016/j.neuropharm.2011.05.012. PubMed PMID: 21640128; PubMed Central PMCID: PMC3130070.
6. Lynch W J, Carroll M E. Regulation of intravenously self-administered nicotine in rats. Exp Clin Psychopharmacol. 1999; 7(3):198-207. Epub 1999/09/03. PubMed PMID: 10472507.
7. U.S. Patent Application Publication Serial No. US2007/0272166 A1, Kanno, A., “Chamber Device, Respiratory Pharmacological Test System and Pharmacological Safety Test Method”, Nov. 29, 2007.
8. U.S. Pat. No. 7,527,021 B2, Mead, et al., “Non-Invasive Drug Self-Administration System for Animals”, issued May 5, 2009.
9. U.S. Pat. No. 7,086,350 B2, Tecott, et al., “Animal Cage Behavior System”, issued Aug. 8, 2006.
10. Kantak, K., et al., “Ethanol vapor self-administration in adult C57BL/6J Male Mice”, Drug and Alcohol Dependence 86 (2007), 123-131.
11. Ponzoni, L., et al., “Different physiological and behavioural effects of e-cigarette vapour and cigarette smoke in mice”, European Neurophyschopharmacology (2015) 25, 1775-1786.
12. Xiao, Y., et al., “Rat α3/β4 Subtype of Neuronal Nicotinic Acetylcholine Receptor Stably Expressed in a Transfected Cell Line: Pharmacology of Ligand Binding and Function”, Molecular Pharmacology, 54:322-322 (1998).

Unless clearly specified to the contrary, there is no requirement for any particular described or illustrated activity or element, any particular sequence or such activities, any particular size, speed, material, duration, contour, dimension or frequency, or any particularly interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. It should be appreciated that aspects of the present invention may have a variety of sizes, contours, shapes, compositions and materials as desired or required.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

I claim:

1. A system for self-administration of an agent to an animal, said system comprising:
an enclosure for the confinement of an animal;
a sensor that produces a signal when purposefully activated by the animal in said enclosure, wherein said purposefully activation defines a first behavior of the animal that is located at a first behavior location; and
an agent dispenser that is configured to provide the agent in said enclosure in response to said sensor being purposefully activated, wherein the agent is provided remotely from said first behavior location so as to require said animal to travel to the remotely provided agent at a remote provision location, wherein said traveling defines a second behavior of the animal.

2. The system of claim 1, wherein said agent dispenser is in material communication with an agent supply.

3. The system of claim 2, wherein said agent supply further comprising:
an agent chamber for containing the agent;
a heating source that gives heat to said agent chamber; and
a pressurization source for pressuring the agent in the agent chamber.

4. The system of claim 3, wherein said agent supply further comprising:
a conduit that materially couples said agent chamber and said agent dispenser;
wherein a valve is interposed between said agent chamber and said agent dispenser within said conduit and is operable to control the providing of the agent in said enclosure based on the signal from the sensor.

5. The system of claim 1, wherein the sensor is at least one of the following: pressure sensor, optical sensor, force sensor, or acoustic sensor.

6. The system of claim 1, wherein the sensor is a nosepoke hole sensor.

7. The system of claim 1, further comprising:
at least one pseudo sensor that is of the same activation type as the sensor and does not provide the agent to said enclosure.

8. The system of claim 1, wherein said agent dispenser is configured to provide at least one of the following into the enclosure: solid, liquid, gas, vapor, or aerosol.

9. The system of claim 1, wherein said agent dispenser is configured to provide the agent wherein the agent is at least one of the following: cigarette smoke, electronic cigarette smoke, cannabis smoke, crack cocaine smoke, nicotine, flavoring, or methanol.

10. The system of claim 1, wherein said agent dispenser is configured to provide the agent wherein the agent is at least one of the following: nicotine, flavoring, or methanol.

11. A method for self-administering an agent to an animal, said method comprising:
providing said animal in an enclosure;
allowing said animal to purposefully activate a sensor from said enclosure, wherein said purposeful activation defines a first behavior of the animal that is located at a first behavior location;
sending a signal from said sensor when purposefully activated by the animal; and
providing said agent in said enclosure in response to said signal, wherein the agent is provided remotely from said first behavior location so as to require said animal to travel to the remotely provided agent at a remote provision location, wherein said traveling defines a second behavior of the animal.

12. The method of claim 11, wherein the agent is at least one of the following:
cigarette smoke, electronic cigarette smoke, cannabis smoke, crack cocaine smoke, nicotine, flavoring, or methanol.

13. The method of claim 11, wherein the agent is at least one of the following: nicotine, flavoring, or methanol.

14. The method of claim 11, wherein said method further comprising:
heating the agent; and
pressurizing the agent.

15. The method of claim 14, further comprising:
controlling the agent being provided into said enclosure based on the signal from the sensor.

16. The method of claim 11, further comprising:
controlling the agent being provided into said enclosure based on the signal from the sensor.

17. The method of claim 11, wherein the agent is nicotine and 1.5-2 ug of nicotine is provided to the enclosure when the sensor is purposefully activated.

18. A method of evaluating an agent in an animal, said method comprising:
placing the animal in an agent evaluating system comprising a system for self-administration of an agent to an animal of claim 1;
allowing the animal to acquire an agent-operant behavior by utilizing said system for self-administration of an agent to an animal of claim 1; and
appraising the animal of physical and/or mental effects of the acquisition of said agent operant behavior.

19. The method of claim 18, wherein said agent is at least one of the following: cigarette smoke, electronic cigarette smoke, cannabis smoke, crack cocaine smoke, nicotine, flavoring, or methanol.

20. The method of claim 18, wherein said step of appraising the animal is at least one of the following: fixed ratio testing, progressive ratio test, agent conditioned place preference test, withdrawal behavior test, elevated plus maze test, somatic withdrawal test, hyperalgesia test, agent receptor ligand binding in brain tissue test, proteomic test of changes in agent receptor, or proteomic test of key protein expression in a brain of an chronic treated animal.

21. A method of evaluating an agent in an animal, said method comprising:
placing the animal in an agent evaluating system comprising a system for self-administration of claim 1;
allowing the animal to operantly condition itself between a purposeful activation action and a providing of said agent to said system for self-administration of claim 1; and
appraising at least one effect of the animal due to the agent.

22. The method of claim 21, wherein said agent is at least one of the following: cigarette smoke, electronic cigarette smoke, cannabis smoke, crack cocaine smoke, nicotine, flavoring, or methanol.

23. The method of claim 21, wherein said step of appraising the animal is at least one of the following: of fixed ratio testing, progressive ratio test, agent conditioned place preference test, withdrawal behavior test, elevated plus maze test, somatic withdrawal test, hyperalgesia test, agent receptor ligand binding in brain tissue test, proteomic test of changes in agent receptor, or proteomic test of key protein expression in a brain of an chronic treated animal.

24. A method of evaluating an agent in an animal, said method comprising:
placing the animal in an agent evaluating system comprising a system for self-administration of claim 1;
allowing the animal to become reliant upon the agent by the animal self-administering said agent to itself by utilizing said system for self-administration of claim 1; and
appraising at least one effect of the animal due to said animal used to be or is reliant on said agent.

25. The method of claim 24, wherein said agent is at least one of the following: cigarette smoke, electronic cigarette smoke, cannabis smoke, crack cocaine smoke, nicotine, flavoring, or methanol.

26. The method of claim 24, wherein said step of appraising the animal is at least one of the following: fixed ratio testing, progressive ratio test, agent conditioned place preference test, withdrawal behavior test, elevated plus maze test, somatic withdrawal test, hyperalgesia test, agent receptor ligand binding in brain tissue test, proteomic test of changes in agent receptor, or proteomic test of key protein expression in a brain of an chronic treated animal.

27. The system of claim 1, further comprising:
an agent for use with said agent dispenser.
